(19) United States
(12) Patent Application Publication
(10) Pub. No.: US 2015/0310473 A1
(43) Pub. Date: Oct. 29, 2015

(54) A method for collecting points related to promotions or to other activities destined to comercial and/or market research purposes

(71) Applicant: PROGRESS CONSULTANT S.R.L., Milano (MI) (IT)

(72) Inventor: Stefano Cacciami, Milano (IT)

(73) Assignee: PCH S.R.L., Milano (IT)

(21) Appl. No.: 14/647,109

(22) PCT Filed: Aug. 8, 2013
(86) PCT No.: PCT/IB2013/056483

§ 371 Date: May 25, 2015

(30) Foreign Application Priority Data
Dec. 7, 2012 (IT) FI2012A000274 7
Mar. 6, 2013 (IT) FI2013A000045

(51) Int. Cl. G06Q 30/02; G06Q 30/06

(52) U.S. Cl. CPC G06Q 30/0222; G06Q 30/0224; G06Q 30/0633

(57) ABSTRACT

A method for participation to promotional or commercial initiatives at purchase or reception of one or more products includes: processing one or more user codes, each one being associated in a univocal manner to one user; providing a central server and one or more local servers in communication with the central server; purchasing products and sending to the local server the user code associated with the electronic list of purchased products; determining, from a reference list, whether the purchased products that are associated to the user code are part of a promotion or other commercial activity; sending to the central server the code associated with the list of purchased products after reception by the local server of a consensus input; receiving and memorizing the data by the central server; and processing the data to verify the possible reaching of a reference value for each user associated to the code.

### TECHNICAL FIELD

The present invention refers to the technical field relative to the technology for the acquisition of points and the participation to promotional, commercial and market research initiatives, discount tickets, etc., at the moment of the purchase of products, but that preserve the product exposed in the selling point from fraudulent tamperings.

In particular, the invention refers to an innovative method, and relative system of apparatus, that reduces the risk of fraudulent damage of the commercial products present on the shelves of the selling points, allowing at the same time the acquisition of points and relative participation to promotional or commercial activities in general and to market research activities, discount tickets, etc.

### BACKGROUND ART

It is known that in commercial centers, and/or other distribution networks, it is often present a certain range of products for sell that are periodically subject to pre-determined commercial initiatives, such as a discount on the subsequent purchase or on the simultaneous purchase of the same product.

Currently in the state of the art, in general, a certain coupon is present that has to be removed from the package and has to be handed out at the moment of the subsequent purchase to benefit from the discount.

In that sense, obviously, there is a high risk of damage of the products exposed since they are often tampered in a fraudulent way with the aim of removing the coupon of interest from the package, but obviously without purchasing the product.

The products therefore results damaged and has to be removed from the shelves and discarded, with obvious and huge economic damages for the commercial center.

Further, the coupon removed can be reproduced in a fraudulent way with fake copies (for example through the use of a scanner and software programs of graphic processing), producing further damages to the commercial center in question and obviously to the promoter of the initiative.

The same problem is present on products that have removable coupons and codes, such as those that can be sent physically or online in order to have a certain economic advantage in return, such as the participation to a contest or a point collection, etc. also in this case there is a certain tendency to remove physically those coupons, producing physical damage to the product in question.

Last but not least, for instance, in certain cases it is even necessary to open the package to read a certain code present inside the package and send it by SMS or the Internet to participate to a certain promotion. It is clear that the opening of the package determines the physical discard of the product.

Further, the taking away in a fraudulent way of a certain code present on the package of a product without buying it is an obvious action of fraud that damages also the holder of such an initiative.

### DISCLOSURE OF INVENTION

It is therefore the aim of the present invention to provide an innovative method, and relative system of apparatus, which allows to solve at least in part said technical inconveniences.

In particular, it is the aim of the present invention to provide an innovative method, and relative system of apparatus, which allows to eliminate the presence of particular codes, removable and unremovable, present on the packages of the products and linked to commercial initiatives, thus eliminating the risk that someone can in a fraudulent way damage physically the package itself in the attempt to read or take said codes off.

It is also the aim of the present invention to provide a purchase method that, although preserving the physical integrity of the products for sell, allows a participation to any initiative and that results safe, anti-fraud and therefore reliable, without any cost and/or activity by the consumer.

These and other aims are therefore obtained with the present method of purchase of one or more products, in accordance with claim 1.

The method comprises the following operations:
Arrangement of a central server (3) and of one or more local servers (10) placed in communication, for example through the Internet, with the central server (3);
Generation of one or more user codes (1), each one being associated in a univocal manner to one user;
Generation of an electronic list of products purchased by the user through the reading of an identification code associated to the product purchased, for example the classical bar code, also called EAN code, and sending to the local server (10) of the user code (1) and of said electronic list of products purchased and associated with the user code;
Comparison in the local server (10) of a reference list, containing one or more products that are subject to a pre-determined promotion, with said electronic list of products purchased by the user in such a way as to determine a second list containing only the products purchased that are subject to said promotion and associated to the user code (1);
Sending from the local server (10) to the central server (3) of the user code (1) and of said second list associated with the user code (1), said operation of sending being performed following the reception by the local server (10) of a consensus input;
Reception and memorization by the central server (3) of said data received;
Processing of said data in the central server (3) to verify the eventual reaching of a reference value for each user associated to the code (1).

The present method allows to solve the technical problems mentioned above for the following reasons.

The eventual promotion or activity, of any nature it may be, does not need anymore to be present physically on the package of the product by means of a removable coupon or a code generally placed inside the package and/or for example covered with silver varnish, inserted in a multi-page format, etc. On the contrary, is now in the form of an electronic datum memorized electronically in a specific reference list contained in the central server and updatable, obviously, from time to time.

In this way, the product is physically exempt from any identification code of any promotion and takes place an analytical comparison of the electronic list of the products purchased with the list of products that are subject to such initiatives directly in a specific server specifically programmed. An algebraic comparison operation allows to extrapolate “algebraically” an eventual list of one or more products that are subject to a certain promotion and which are associated univocally to the user that has purchased them.

In this way, in an automatic manner, the user is capable of automatically benefiting from a certain promotion without the need that a specific code, on the product is present.

In this way, removable coupons and particular codes present on the packages can be easily eliminated physically, solving the problem of the fraudulent physical damage of the product.

The user, moreover, is now unbound from any further operation to benefit from the promotion, except from that of the normal purchase, of course.

In this way, above all frauds are not possible since the access to the promotion and/or other activity is possible only if a regular purchase is made without the need to call toll-free numbers or to send sms, e-mails or other.

Such a system allows, with absolute certainty, to verify the purchase of the product in promotion since, only after the consensus has been made, the local server communicates to the central server the list of the products extrapolated from the comparison. The consensus can easily be given for example following a payment, a signal of consensus in electronic form that from the cash register goes to the server.

The user will therefore be reminded in different ways and terms either by the goods and/or services production companies, distribution chains, etc., and/or by the proponent itself, to send the data for the registration mentioned above.

The present method is valid for any type of initiative of the promotional type, commercial or not, therefore also of different nature.

Advantageously, an operation of sending of the user code (1) to an electronic device (2) of the user is foreseen for visualizing said code (1).

Advantageously, an operation of visualization of the user code (1) on said device (2) is foreseen and, before the purchase of the products, the reading of said user code (1) with a reading apparatus (4) of the code connected to the local server (10) in such a way that the shopping purchased results associated with said user code (1).

Advantageously, said reading apparatus (4) is the same bar code reader for the purchase of products.

Advantageously, the reception by part of the local server (10) of a consensus input comprises the sending of a consensus signal following the payment made.

Advantageously, the operation of processing of the data to verify the eventual reaching of a reference value comprises a comparison in the central server of a value assigned to the products purchased or for the number of products purchased by each user with a reference value.

Advantageously, the user code generated is at choice:
A bar code, eventually provided with a numeric or alpha-numeric code;
A tax identification code;
A biometric code.

Advantageously, the user code is generated by the central server (3).

Advantageously, said user code is sent to the user either by sms, mms, e-mail, mobile application.

Advantageously, the central server contains a complete list of products that are subject to pre-determined commercial initiatives, each local server downloading periodically from the list from the central server.

It is also here described an assembly of apparatus for performing the purchase of one or more products and comprising:
A central server (3) and one or more local servers (10) placed in communication with the central server (3) through the Internet, the central server (3) or the local servers containing an electronic list of reference of one or more products;
A device for the generation of one or more user codes (1), each user code (1) being associated in a univocal manner to a user;
A device (4) for the electronic acquisition of the products purchased and configured to generate a first electronic list of products purchased by the user and associated with the user code (1) generated, the device (4) being programmed to send to the local server (10) the user code (1) and said first electronic list of products purchased and associated with said user code;
And wherein the local server (10) foresees a processor programmed in such a way as to make a comparison of said electronic list of reference, containing one or more products that are subject to a pre-determined promotion, with said first electronic list of products purchased by the user, and create a second electronic list containing only the products purchased belonging to said reference list and associated with the user code (1);
And wherein the local server is further programmed to send through the Internet to the central server (3) said second list following the reception of an electronic consensus input, the central server being programmed to process said data and verify the eventual reaching of a reference value for each user associated to the code (1).

Advantageously, the device for the generation of the user code is the processor of the central server (3) which is programmed to send through the Internet the code generated on the mobile phone of the requesting user.

Advantageously, the device for the electronic reading of the products purchased is a reading device (4) of bar codes placed in communication with the local server (10), the user code being preferably a bar code that is read through said reading device (4).

Advantageously, it is here described an assembly of apparatus for operating a purchase method of one or more products as described.

### BRIEF DESCRIPTION OF DRAWINGS

Further features and advantages of the present method, according to the invention, will result clearer with the description that follows of some embodiments, made to illustrate but not to limit, with reference to the annexed drawings, wherein:

FIG. 1 shows a smartphone on which the univocal code for the user is downloaded; the smartphone can be substituted by a mobile phone capable of displaying MMS, e-mail formats and/or any other electronic format;

FIG. 2 shows a central server 3 that processes and memorizes the reference code;

FIG. 3 shows an ordinary reader 4 of the bar code that appears on the palmtop and through which the shopping is made as per FIG. 4;

FIG. 4 shows the reading of the shopping and the loading of it on the local server 10; the reading can take place with the ordinary fixed cash register readers or with the gun;

FIG. 5 shows the payment transaction and the subsequent sending of the data to the central server 3 for the processing of the data and the consequent assignation to the promotional activities inserted, as indicated in FIG. 4;

FIG. 6 shows a general function scheme of the present system.

### DESCRIPTION OF SOME PREFERRED EMBODIMENTS

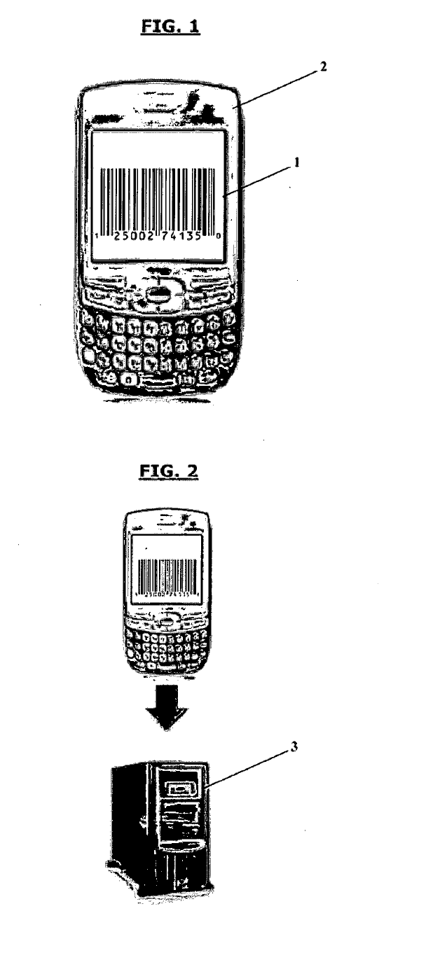

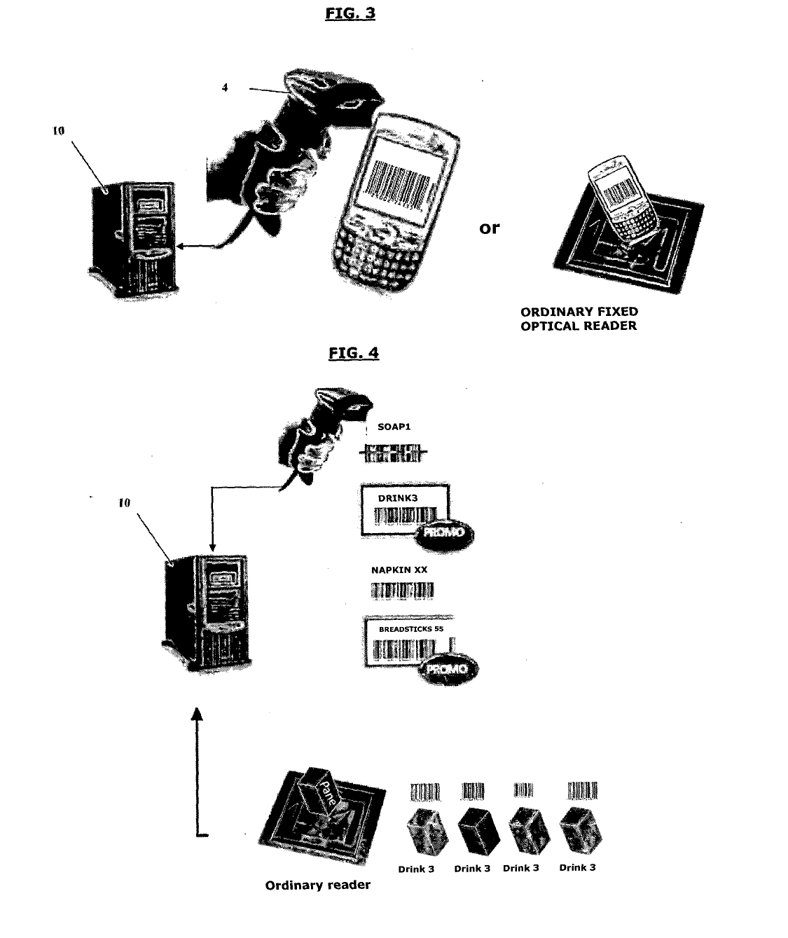

As shown in FIG. 1 and in FIG. 2, it is initially foreseen a phase of generation of a bar code 1.

The code 1 is sent to the user through an sms system, the web, or a specific application. The central server 3 will foresee a specific processor programmed to generate the code to then keep it in the memory with the consequent association, in a univocal manner, of each user to the bar code generated.

Such a code will be composed of a bar code, eventually combined with a further alpha numerical or just numerical code. In this way, in case of failed reading by the electronic instruments arranged for the identification of the bar codes, it will be possible to insert said further code manually through the keyboard of the cashier.

As already said, the generation of a univocal code can happen in different ways.

For example, it is possible to download from the Internet a specific application to a mobile phone device 2 already of common use, such as a smartphone, an I-phone and palmtops in general. It has long been known the possibility of downloading applications of any type for the most varied needs.

Following the insertion of the personal data requested, and therefore following the filling-in of the data requested, the application generates the code 1 represented precisely in the figure and associated to the single user that has requested it. In that sense, it is foreseen a registration of the user to the system (central server 3) through the web or the telephone (sms, mms, web application) and that is obviously preliminary to the generation of the code.

The code generated is memorized in the central server 3 and sent to the user.

It is to be noted how, although bar codes are mentioned, any type of code can be realized.

In a further case tax identification codes can be mentioned. In that sense, the server that generates the code acquires such data that it is capable of reproducing the tax identification code or, alternatively, requires directly the insertion of the tax identification code.

In a further example the server generates a code in the form of a biometric code. A biometric recognition system is a particular type of information technology system that has the functionality and the purpose of identifying a person on the basis of one or more biological and/or behavioral features (biometry), comparing them with the data acquired before and present in the database of the system, through algorithms and sensors of acquisition of the data in input (for example conformation of the retina).

In a further example the code can be a code of the user already existing for other different initiatives that will be combined to the code sent by the system, allowing as a consequence a binary use of them.

FIG. 2 shows schematically the central server 3 and the memorization in the server of the code generated by the application of the palmtop. The application is therefore in communication with the central server.

Alternatively, the code can be obtained by sending a telephone sms to a pre-defined number that always depends on the server 3 for the generation and the return of the code or with the access to the server 3 through a web page or through specific application.

In the case of generation through the web, the code can be sent to the user through an e-mail, mms or displayed by the application.

In any case, a univocal identification code of the user has been generated and is present in memory in the central server 3.

At this point the user, at the moment of the purchase of consumption goods in the reference selling point (for example the supermarket), reads the own code through an ordinary reader and/or gun 4 for bar codes and in use for the reading of the shopping. The gun 4 and/or the ordinary reader reads the identification code of the user that appears on its own mobile phone. Alternatively, as per FIG. 3, the code can be read or inserted manually directly at the cashier's desk on the reader commonly in use for the pass of the shopping items.

The code is therefore memorized by a local server 10 specifically programmed; to this code the purchase of the products by the user is associated, as per FIGS. 3 and 4.

The example of FIGS. 3 and 4 shows precisely the reading of the code 1 that is memorized in the local server 10 together with the readings of the bar codes of the products purchased and associated with said code, FIG. 4 shows products as a way of example offered in promotion or that are subject to other activities.

Thus the user, before doing the shopping, reads its own code that appears on the palmtop with the reader 4 which, in turn, sends the code to the local server 10. At this point the user does the shopping with the consequent reading of the products purchased by it (reading of the bar codes) with the reader 4 and, therefore, as the products are read they finish in memory in the local server associated with its code 1.

The local server, obviously, will foresee an appropriate processor capable of memorizing the products purchased and the code associated with these products.

This can be easily implemented since the codes of the products are alpha numeric bar codes as well as the user code which, in any case, can be “numbered”.

Such data will be stored and memorized on the local server 10 to permit the identification of the promotional codes or the codes subject to other activities and as a consequence be able to extract for the sending to the central server 3 after the payment. This is possible because, in addition to generating the codes, the central server 3 has in memory all the products in promotion and not, which can be updated continuously. The processor of the central server contains in memory (for example through memorization of the relative bar codes) all the products that are subject to a certain promotion. There exists a communication via the Internet that allows the local server 10 to find and download periodically the list of the products in promotion and therefore identify them among the products purchased by the user.

When the user purchases a product, the local server 10 identifies, among all the products purchased, those belonging to particular promotions by simply comparing “electronically” the list downloaded by the central server with the products purchased.

In fact, the processor of the local server makes an “algebraic” comparison of the codes that represent the products subject to a promotion with the codes of the products purchased by the user and thus writes an electronic list of codes representing the products purchased by the user, univocally associated with the user code in question, and subject to a certain promotion.

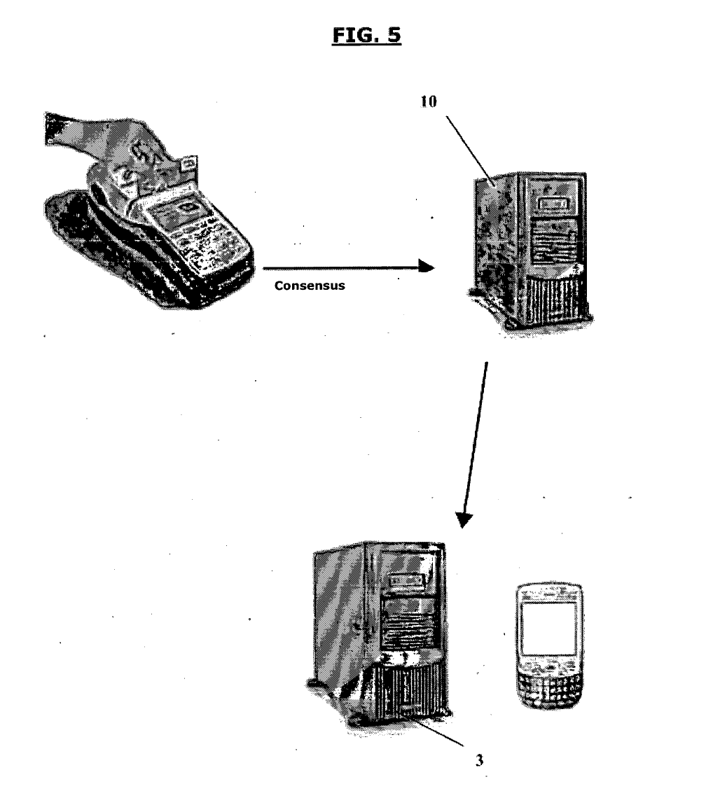

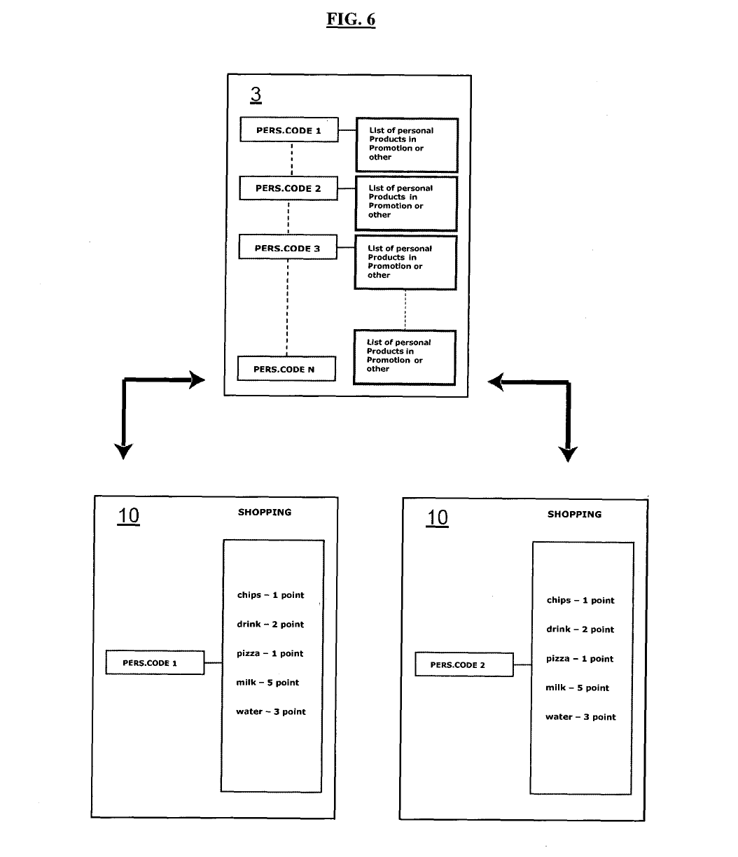

As per FIG. 5, at the moment of the payment, the personal code of the user associated to the products that are subject to a promotion is sent from the local server 10 to the central server 3.

This is because at the moment of the payment, for example by credit card or debit card, an electrical consensus signal is generated, which can be eventually sent also from the cashier itself towards the local server.

Subsequently, on the basis of the rules of each single activity, once the indicated objectives will be reached, the server 3 will inform the point balance for the sending of the presents and/or the participation with consequent winning to contest operations. In case of other activities, such as market researches, idoneous activities will be developed for obtaining objectives indicated by them.

FIG. 6 sums up all the procedure for clarity purposes.

The local servers 10 are placed in the management of commercial centers or other distribution points or areas that permit the development of what has been indicated in the procedure of code recognition. For example, a commercial center can foresee its local server 10. The central server 3 is in communication through the Internet with the local servers in such a way that they can exchange information.

The central server contains all the codes processed by the users (COD1, COD2 . . . CODn) and the list of the products that are subject to promotions and/or different initiatives, obviously updatable from time to time.

The local servers 10, for each user that does the shopping with the reader, associates to the code of the user the shopping list and extrapolates the promotion goods by simply downloading periodically the list present in the central server and operating a simple comparison.

Differently, in a variant of the invention, each local server 10 can be updated locally on the products subject to promotions and therefore, in that case, the central server does not contain the list of the products of all the activities, but will memorize the codes indicated by such a selling point with the promotion goods purchased.

For each user that does the shopping the local server is capable of identifying the products subject to promotions with a comparison of the product purchased with the list of the promotion goods. The local server is programmed to send such information to the central server once the payment has been made. Only when the user makes the payment, the local server 10 receives a consensus to send the client code 1 with the products in promotion purchased to the central server 3 which keeps them in memory, processing them for the calculation of the reaching of a pre-established prize or of other activities.

If, for example, a prize is won with the purchase of specific n products, the central server 3 will count for each user if the pre-fixed n number has been reached, after which it will assign the prize by sending an sms of notice or other, for example.

In the case of contest activities (chance) the eventual winning will be directly communicated to the user by e-mail, sms or other using programs suitable for the correct determination of the chance.

Although the preferred embodiment of the invention foresees the reading with the readers 4 (see FIG. 4) an alternative is possible in which the code 1 is inserted manually at the moment of the payment at the cashier's desk (or a reader at the cashier's desk reads the code) and the shopping is normally passed below the fixed reader that reads it (reading of the bar codes) and sends it to the local server 10 associated to the specific user.

The present invention, as already said, is applicable not only in the classical case of point collection for prize or discount accumulation, but also for a market research.

The central server 3, keeping in memory for each user the products purchased by him, can make for each user an average of the most used products by him, for example, either as market research as a means, for example, of emitting automatically customized discount tickets on the most purchased products. In this case, at the moment of the purchase, the local server will send the entire shopping list to the central sever and not only the list of the items that are subject to promotions.

In the present description the phrases promotional/commercial initiatives or just promotional or just commercial activities mean the assembly of all the activities such as the acquisition of points for contests or the assignment of prizes, discount tickets, market research, etc., at the moment of the purchase of products.

The invention claimed is:

1. A purchasing method of one or more products, comprising:
providing a central server (3) and one or more local servers (10) placed in communication with the central server (3);
generating, through a processor, one or more user codes (1), each one being associated in a univocal manner to one user;
generating a first electronic list of products purchased by the user through a reading of an identification code of a purchased product and sending, to a local server (10), a generated user code (1) and said first electronic list of purchased products that are associated with said user code;
providing an electronic reference list and comparing in the local server (10), through the processor of said local server, said reference list, containing one or more products that are subject to a pre-determined promotion, with said first electronic list of products purchased by the user to determine a second electronic list, associated with the user code (1), and containing only the purchased products present in the electronic list of reference;
sending from the local server (10) to the central server (3) the user code (1) and said second list associated with the user code (1), the step of sending being performed following reception by the local server (10) of a consensus input;
receiving data by the central server (3) and memorizing said received data; and
processing said received data in the central server (3) through the processor thereof to verify a possible reaching of a reference value for each user associated to the user code (1).

2. The method, as per claim 1, further comprising the step of sending of the user code (1) to an electronic device (2) of the user for visualizing said user code (1).

3. The method, as per claim 2, further comprising the step, before purchasing the products, of reading said user code (1) with a reading apparatus (4) of the user code connected to the local server (10) such that the purchased products are associated with said user code (1).

4. The method, as per claim 3, wherein said reading apparatus (4) is a bar code reader that is used for the purchase of the products.

5. The method, as per claim 1, wherein the reception by the local server (10) of the consensus input comprises sending a consensus signal following payment.

6. The method, as per claim 1, wherein the step of processing of the received data to verify the possible reaching of the reference value comprises a comparison in the central server of a value assigned to the purchased products or for a number of products purchased by each user with a respective reference value.

7. The method, as per claim 1, wherein the user code is selected from the group consisting of a bar code, a bar code provided with a numeric or alpha-numeric code, a tax identification code, and a biometric code.

8. The method, as per one claim 1, wherein the user code is generated by the central server (3).

9. The method, as per claim 8, wherein said user code is sent to the user either by sms, mms, e-mail, or a mobile application.

10. The method, as per claim 1, wherein the central server contains a complete list of products that are subject to pre-determined commercial initiatives, each local server downloading periodically from the complete list from the central server.

11. An assembly of apparatus for performing a purchase of one or more products, comprising:
a central server (3);
one or more local servers (10) placed in communication with the central server (3), the central server (3) or the local servers containing an electronic reference list of one or more products;
a device configured to generate one or more user codes (1), each user code (1) being associated in a univocal manner to a user; and
a device (4) configured to electronically record purchased products and to generate a first electronic list of the purchased products by the user that are associated with the generated user code (1), the device (4) being programmed to send, to the local server (10), the user code (1) and said first electronic list of the purchased products that are associated with said user code,
wherein the local server (10) comprises a processor programmed to make a comparison of said electronic list of reference, containing one or more products that are subject to a pre-determined promotion, with said first electronic list of products purchased by the user, and to create a second electronic list containing only the purchased products belonging to said reference list that are associated with the user code (1), and
wherein the local server is further programmed to send to the central server (3) said second list following reception of an electronic consensus input, the central server being programmed to process data from said second list and verify a possible reaching of a reference value for each user associated to the user code (1).

12. The assembly, as per claim 11, wherein the device configured to generate the user code is the processor of the central server (3), which is programmed to send the code generated on a mobile phone of a requesting user.

13. The assembly, as per claim 11, wherein the device configured to electronically record the purchased products is a reading device (4) of bar codes placed in communication with the local server (10), the user code being a bar code that is read through said reading device (4).

14. An assembly of apparatus for operating a purchase method, wherein the apparatus is configured to perform the following method:
providing a central server (3) and one or more local servers (10) placed in communication with the central server (3);
generating, through a processor, one or more user codes (1), each one being associated in a univocal manner to one user;
generating a first electronic list of products purchased by the user through a reading of an identification code of a purchased product and sending to a local server (10) of the generated user code (1) and of said first electronic list of purchased products and associated with said user code;
providing an electronic list of reference and comparing in the local server (10), through the processor of said local server, said reference list, containing one or more products that are subject to a pre-determined promotion, with said first electronic list of products purchased by the user to determine a second electronic list, associated with the user code (1), and containing only the purchased products present in the electronic list of reference;
sending from the local server (10) to the central server (3) the user code (1) and said second list associated with the user code (1), the step of sending being performed following reception by the local server (10) of a consensus input;
receiving and memorizing, by the central server (3), said received data; and
processing said received data in the central server (3) through the processor thereof to verify a possible reaching of a reference value for each user associated to the code (1).
